(19) United States
(12) Patent Application Publication
(10) Pub. No.: US 2003/0047296 A1
(43) Pub. Date: Mar. 13, 2003

(54) Aqueous suspension providing high opacity to paper

(76) Inventor: Josep Maria Gussinyer Canadell, Sant Joan De Les Fonts (ES)

Correspondence Address: Steinberg & Raskin, 15th Floor, 1140 Avenue of the Americas, New York, NY, 10036-5803, US

(21) Appl. No.: 10/221,713

(22) PCT Filed: Mar. 14, 2001
(86) PCT No.: PCT/ES01/00098

(30) Foreign Application Priority Data
Mar. 16, 2000 (ES) P 200000636

(51) Int. Cl. D21H 17/66; C04B 11/00

(52) U.S. Cl. 162/158; 162/181.3; 162/183; 106/772

(57) ABSTRACT

The aqueous suspension contains hydrated n calcium sulfate (CaSO₄ nH₂O), the value of n ranging from 0 to 2 (0<n<2) and an additive. The method for preparing said aqueous suspension involves the following steps: a) mixing the calcium sulfate and at least one of said additives with water and b) homogenizing the mixture under strong agitation. The method for preparing the paper includes adding said aqueous suspension to the cellulose fiber suspension.

### FIELD OF THE INVENTION

This invention concerns the field of paper manufacture and refers to an aqueous suspension for addition to cellulose fibre, paste, in which such suspension includes calcium sulphate plus at least one additive.

The addition of this aqueous suspension to the cellulose fibre paste during the paper preparation process causes a surprising increase in the opacifying capacity of calcium sulphate.

### BACKGROUND OF THE INVENTION

In paper-making processes currently existing in the state of the art, different additives are normally added to the aqueous suspension of cellulose in order to give it the desired characteristics (physical and mechanical resistance values). Nevertheless, the amount of additives added in relation to the amount of cellulose may not exceed a certain threshold.

In the state of the art, the addition of calcium sulphate to the aqueous cellulose fibre suspension during the paper-making stage is known to give certain properties to the final product. The designation of calcium sulphate covers any compound that has the general formula of CaSO₄nH₂O, where n has a value ranging between 0 and 2 or higher).

These properties are generally related to greater physical and mechanical resistance of paper, lower energy consumption, better performance of the filler (added inorganic compounds such as additives), lower consumption of cellulose paste, etc.

Nevertheless, calcium sulphate has a low paper-opacifying capacity and, therefore, the addition of calcium sulphate to the cellulose fibre suspension during paper preparation, even at quantities above 30% by weight, does not sufficiently opacify the paper thus obtained to make it particularly suitable for printing. In other words, the maximum amount of calcium sulphate that can be added with respect to the amount of cellulose is not enough to give paper a sufficiently high degree of opacity.

When considering the high amount of paper used for printing and writing, in particular in publications, press uses, notebooks and books for school use and other similar purposes, it is evident that paper opacification is a significant problem.

The low opacifying capacity of paper containing calcium sulphate is the main reason that manufacturers of paper for printing and writing in general add substances such as titanium dioxide with greater opacifying capacity than calcium sulphate to the paste used to manufacture paper. Nevertheless these highly opacifying additives are costly and noticeably increase the cost of paper obtained in this way.

Hence, the need to find a less costly solution to the problem of paper opacification can be easily understood. Surprisingly, in this invention, the addition of small quantities of at least one additive to calcium sulphate prior to the addition thereof to the cellulose fibre solution for paper, manufacture has been found to significantly increase the opacifying capacity of this calcium sulphate. Suitable additives for this invention include: kaolin, calcium carbonate, talc, titanium dioxide, aluminium silicate, calcium silicate, other silicates and/or their mixtures, as described below.

### DESCRIPTION OF THE INVENTION

This invention refers to an aqueous suspension for addition to the cellulose fibre paste used in paper-making, in which the suspension includes calcium sulphate and at least one additive Suitable additives for this invention are, for example: kaolin, calcium carbonate, talc, titanium dioxide, aluminium silicate, calcium silicate, other silicates and/or their mixtures. Due to the variety of compounds that show suitable behaviour in an aqueous suspension according to this invention, the additives indicated can be understood to be only examples of non-limiting additives.

This invention also refers to a process used to prepare this aqueous suspension that includes calcium sulphate and at least one additive.

This invention also refers to a process to obtain paper that includes the preparation of this aqueous suspension that contains calcium sulphate and at least one additive, and the addition of this Suspension to the aqueous cellulose fibre suspension used to manufacture paper.

In this invention, calcium sulphates with differing degrees of hydration can be used, except for natural calcium sulphate anhydrous. There are two kinds of calcium sulphates with n=0: natural anhydrous and artificial anhydrous. Natural calcium sulphate anhydrous, which is found in quarries mixed with calcium sulphate with n=2, cannot be used in a suspension according to this invention. In contrast, artificial calcium sulphate anhydrous, which comes from calcium sulphate dihydrate that has been heated to remove 2 moles of water, can be used in this invention, requiring simply more time and a higher stirring speed to obtain an aqueous suspension according to the invention.

Without intending to limit the scope of this invention in any way, it is postulated that when at least one of these additives is mixed with calcium sulphate in water, this additive is included in the crystalline structure of calcium sulphate modifying the percentage of reflected and/or refracted light rays and therefore modifying the opacifying capacity of this calcium sulphate.

This structural modification of calcium sulphate crystals does not occur if the additive is added in the presence of the aqueous cellulose fibre suspension. It is postulated that the cellulose rapidly attracts calcium sulphate, thereby preventing any possible transformation of the properties of calcium sulphate crystals.

The addition of additives of the kaolin, calcium carbonate, talc, titanium dioxide, aluminium silicate or calcium silicate type to the aqueous cellulose fibre suspension during paper-making is well known in the state of the art. Nevertheless, it is important to stress that in the state of the art, there is no description or suggestion that the combined use of calcium sulphate together with at least one additive prior to the addition to the cellulose fibre suspension would cause a significant increase in the opacifying capacity of calcium sulphate. This increase does not result simply from the sum of the opacifying capacities of calcium sulphate and the additive, but rather from a modification of the crystalline structure of calcium sulphate, which causes an opacifying effect that is surprisingly higher than expected.

In an aqueous suspension according to this invention, calcium sulphate and the additive(s) are found at a ratio by weight between 100:1 and 1:1, preferably between 50:1 and 2:1.

In an aqueous suspension according to this invention, the ratio between the mixture of calcium sulphate and the additive(s) with respect to water ranges between 0.1% and 80% by weight, preferably between 1% and 25% by weight. In an aqueous suspension according to this invention, the optimal pH value of this suspension ranges between 3 and 9, preferably between 4 and 8.

This invention also refers to a process used to prepare an aqueous suspension that includes calcium sulphate and at least one additive according to the invention. This process consists of; 1) mixing this calcium sulphate and at least one of these additives with water; and 2) homogenising the mixture by stirring vigorously.

In a preferred embodiment of this invention, this calcium sulphate and this additive are mixed together while still dry, before being mixed. with water. In another preferred embodiment of the invention, this calcium sulphate and this additive are added to water separately.

This invention also refers to a process used for paper-making, in which the process is characterised in that a previously prepared aqueous suspension of at least one additive and calcium sulphate is added to the cellulose fibre solution. This process includes the following stages: 1) Preparation of a suspension according to the invention as described above; 2) Preparation of a cellulose fibre suspension in water; 3) Addition of the suspension according to the invention to the cellulose fibre suspension in the paper circuit. In a paper-making process using an aqueous suspension according to this invention, this calcium sulphate and at least one of these additives is kept under suspension by stirring until the time the cellulose paste is added. The stirring time depends on the kind of calcium sulphate used and the kind of additive(s) and is, in general, equal to or greater than 30 minutes.

As an advantage, the paper-making process according to this invention allows highly opaque paper to be obtained at a low cost.

An illustrative, non-limiting example of the invention is given below.

### EXAMPLES

The batch calcium sulphate used specifically in the following tests is CaSO₄x0.3 H₂O (i.e., n=0.3 moles). When this calcium sulphate is added along with at least ;one, additive, in water to create an aqueous suspension according to this, invention, this compound is hydrated to a greater or lesser extent, depending on the value of n.

In the tests described below, a stirring speed of 3000 rpm and. a stirring time of 30 minutes were used, with calcium sulphate hydrated with n=0.3.

Technical Characteristics of the Products Used in the Tests:

Kaolin

PARTICLE SIZE=88-90%<21i

Talc

PARTICLE SIZE=25%<2 μ, residue-free and filtered to 50 μ

CaCO₃

ANALYSIS:

CaCO₃ >99

SiO₂ 0.4

MgO 0.3

Al₂O₃ 0.1

Fe₂O₃ 0.08

SO₄ <0.1

PARTICLE SIZE=particles with a size less than:)

60 μ 99

40 μ 95

20 μ 83

5 μ 38

### Characteristics

WHITENESS FMX-Amber filter 88.6

FMY-Green filter 87.1

FMZ-Blue filter 80.6

Anastase Titanium Dioxide

TiO₂ min. 98.0%

Fe₂O₃ max. 0.1%

SiO₂ max. 0.5%

SO₃ max. 0.5%

P₂O₅ max. 0.55%

PARTICLE SIZE

Residue on sieve of mesh 325 (44 μm);<0.5%

Calcium Sulphate n=0.3

Sieve reject at 53 microns 0.39%

Whiteness Z % hunterlab. 923%

ASTM yellow index E313 2.1

Initial cure time 9 min

### Example 1

### Preparation of Fillers at a Concentration of 10% by Weight

Three different kinds of fillers were prepared:

a) Calcium sulphate dihydrate

90% of saturated CaSO₄ water+10% of CaSO₄.2 H₂O=90% of saturated CaSO₄ water+(8.2% of CaSO₄.0.3H₂O+1.8% H₂O)=91.8% of saturated CaSO₄ water+8.2% of CaSO₄x0.3 H₂O

b) Additive (talc, calcium carbonate, kaolin or titanium dioxide)

90% desionised water+10% additive

c) Calcium sulphate+additive.

90% saturated CaSO₄ water+9% CaSO₄x2H₂O+1% additive or additive mixture=90% water+(7.4% CaSO₄x0.3H₂O+1.6% H₂O=9% CaSO₄ 2H₂O)+1% additive=91.6% water+7.4% CaSO₄x0.3 H₂O+1% additive

To prepare the suspensions, CaSO₄ and/or the additive are gradually added over the water while stirring at 3000 rpm, and stirring is continued for at least 30 minutes before the suspension is added to the fibre suspension.

### Example 2

### Preparation of Paper

1—A cellulose dispersion at a concentration of 1±0.01% (dry) is prepared. A bleached sulphate cellulose paste is used as the starting material, as in the case of all tests.

a) In all tests where the filler Contains calcium sulphate, calcium sulphate-saturated water is used to prepare this dispersion. Calcium sulphate-saturated water has a conductivity of 1.42 mS.

b) In tests where the filler does not contain calcium sulphate, deionised water is used to prepare this dispersion.

The dispersion is prepared in a “Pulper” apparatus or laboratory disintegrator for 2 hours.

2—Samples of the prepared solution are collected using a standard container to ensure that the same quantity of dispersed paste at 1±0.01% is collected at all times. This quantity is 37.478 g.

3—A second dilution of the cellulose paste is made by homogenising the 37.478 g of paste at 1% with 400 g of water:

a) Calcium sulphate-saturated water in tests where the filler contains calcium sulphate.

b) Deionised water in all other cases.

The dilution is carried out in a magnetic laboratory stirrer apparatus at 1100 rpm for 40 sec.

4—Immediately after the stirrer is turned on, one of the fillers prepared in example 1 is added.

Two different tests are conducted for each kind of filler: addition of 30% or 15% of filler, calculated with respect to the cellulose.

Addition of 30% calculated with respect to the cellulose: 1.124 g of filler at 10 are added.

37.478 g of cellulose at 1%=0.37478 g of cellulose (dry).

0.37478×30/100=0.1124 g filler (dry), i.e., 1.124 g of filler at 10%; which represents 23.1% of filler with respect to the total solids.

Addition of 15% calculated with respect to the cellulose: 0.562 g of filler at 10% are added.

37.478 g of cellulose at 1%=0.37478 g of cellulose (dry).

0.37478×15/100=0.0562 g filler (dry), i.e., 0.562 g of filler at 10%; which represents 11.55% of filler with respect to the total solids.

5—After 40 sec., the stirrer is turned off and the dispersion is filtered through a Büchner funnel under vacuum conditions.

The filter used is a cellulose triacetate membrane of pore size of 0.2 microns, sufficiently small to prevent losses.

Once the dispersion is filtered, the filter+paper sheet is removed with Büchner tongs and the dispersion is placed in an oven at 80° C. with forced air circulation until the weight is constant.

6—The dry paper sheet +filter is weighted and the opacity of the entire unit is checked in a photovolt apparatus.

Both the prepared sheet of paper and the filter have a diameter of 9.20 cm. The opacity of the unit is measured at 5 different points on the circumference: at the midpoint and at 4 points at a distance equally apart from each other that is equivalent to half the distance between the midpoint of the sheet and the circumference perimeter.

Once the 5 results have been obtained, the mean of all 5 results is computed. If any of the results vary more than 10% from the mean, the 5 results of this sheet are discarded.

To calculate the opacity of the paper prepared using the process according to the intention described above, the difference between the total opacity (of the sheet of paper+filter) and the filter opacity must be calculated.

[Op(P+F)]−(Op F)=Op P

Op(P+F)=opacity of paper+filter

Op F=opacity of the filter

Op P=opacity of the sheet of paper.

Results

A) From the Group of Additives

Two different tests are performed for each 5 additive (with 30% and 15% of filler with respect to cellulose).

| PRODUCT | OPAC. with 30% | OPAC. with 15% |
|---|---|---|
| Talc | 8.76° | 7.9° |
| Calcium carbonate | 12.25° | 10.2° |
| Calcium sulphate | 14.4° | 12.0° |
| Kaolin | 16.2° | 13.0° |
| TiO₂ | 19° | 17.0° |

B) Aqueous Suspension of Calcium Sulphate+Additive Added to the Cellulose Fibre Suspension.

| | OPAC. with | OPAC. with |
|---|---|---|
| Calcium sulphate + additive | 30% | 15% |
| 10% calcium sulphate | 14.4° | 12° |
| 9% calcium sulphate + 1% Talc | 15.6° | 14.3° |
| 9% calcium sulphate + 1% | 15.1° | 13.6° |
| Calcium carbonate | | |
| 9% calcium sulphate + 1% | 17.6° | 17.0° |
| kaolin | | |
| 9% Calcium sulphate + 1% TiO₂ | 18.3° | 17.4° |

C) Calcium Sulphate and Additive Added Separately to the Cellulose Fibre Suspension

| | OPAC. with | OPAC. with |
|---|---|---|
| Calcium sulphate + additive | 30% | 15% |
| 9% calcium sulphate + 1% talc | 13.7° | 11.5° |
| 9% calcium sulphate + 1% CaO₃ | 14.3° | 11.8° |
| 9% calcium sulphate + 1% | 14.7° | 11.9° |
| kaolin | | |
| 9% calcium sulphate + 1% TiO₂ | 14.8° | 12.5° |
| 10% calcium sulphate | 14.4° | 12° |

Discussion of the Results

The following table shows the increased opacifying capacity of calcium sulphate when this calcium sulphate is prepared and added in combination with one additive (in the case of 30% of fillers calculated with respect to dry cellulose).

| | OPACITY with 30% | Increase with |
|---|---|---|
| | Prepared and added | respect to calcium |
| | together | sulphate only |
| 10% calcium sulphate | 14.4° | |
| 9% sulphate + 1% talc | 15.6° | 8.3% |
| 9% sulphate + 1% CaO₃ | 15.1° | 4.9% |
| 9% sulphate + 1% kaolin | 17.6° | 22.2% |
| 9% sulphate + 1% TiO₂ | 18.3° | 27.1% |

By comparing the results, the addition of calcium sulphate and one additive separately, to the fibre suspension is seen not to produce any particular increase in opacity, whereas if a previously prepared suspension of calcium sulphate and additive is added to the cellulose fibre suspension, a surprising increase in the opacity of calcium sulphate is observed.

1. An aqueous suspension without the presence of cellulosic fibers including calcium sulphate n hydrated wherein n has a value ranging 0<n<2 and an additive capable of modifying the crystalline structure of said calcium sulphate.

2. An aqueous suspension according with claim 1, where the additive is selected from the group consisting of kaolin, calcium carbonate, talc, titanium dioxide, aluminium silicate, calcium silicate, magnesium silicate, other silicates and/or their mixtures.

3. An aqueous suspension according to claim 1 or 2, wherein said calcium sulphate and said additive are present at a weight ratio ranging between 100:1 and 1:1, preferably between 50:1 and 2:1.

4. An aqueous suspension according to any of the previous claims, wherein the ratio between the mixture of calcium sulphate and additive with respect to water ranges between 0.1% and 80% by weight, preferably between 1% and 50% by weight.

5. An aqueous suspension according to. any of the previous claims, wherein the ratio between the mixture of said calcium sulphate and said additive with respect to the cellulose ranges between 1% and 80% by weight, preferably between 5% and 25% by weight.

6. An aqueous suspension according to any of the previous claims, wherein the pH of this suspension ranges between 3 and 9, preferably between 4 and 8.

7. A process for the preparation of an aqueous suspension according to any of the previous claims, that includes:
3) Mixing a calcium sulphate n hydrated wherein n has a value ranging 0<n<2 and at least one additive capable of modifying the crystalline structure of said calcium sulphate with water; and
4) Homogenising the mixture while stirring vigorously.

8. A process for paper-making, that includes the following stages;
1) Mixing calcium sulphate n hydrated and at least one additive with water to obtain an aqueous suspension as defined according to any of claims 1 to 6;
2) Preparing a cellulose fibre suspension in water within the paper circuit; and
3) Adding the aqueous suspension of 1) to the cellulose fibre suspension of 2).

9. Use of an aqueous suspension according to any of claims 1 to 6 in paper-making for increasing the opacity of paper.
